(19) United States
(12) Patent Application Publication
(10) Pub. No.: US 2010/0044362 A1
(43) Pub. Date: Feb. 25, 2010

(54) Oven Having An Adjustable Effective Heating Space

(76) Inventor: Ya-Ping HUANG, Tainan County (TW)

Correspondence Address: FRENKEL & ASSOCIATES, 3975 UNIVERSITY DR., STE. 330, FAIRFAX, VA, 22030, US

(21) Appl. No.: 12/193,982

(22) Filed: Aug. 19, 2008

(51) Int. Cl. A21B 3/00

(52) U.S. Cl. 219/392

(57) ABSTRACT

An oven having an adjustable effective heating space includes an oven body with a scale and a space control knob on the outside to allow manual adjustment of the heating space. Through a transmission assembly and a lever assembly, the position of a heating assembly located in a heating chamber can be adjusted to form an effective heating space with another heating tube in the heating chamber. The size of the effective heating space can be adjusted in a stepless fashion according to user's requirements so that baking and roasting condition can be fine-tuned whenever desired without moving foodstuff or the oven. The oven thus formed provides multiple functions to heat the foodstuff effectively. Roasting can be done simpler and safer with less energy consumption.

### FIELD OF THE INVENTION

The present invention relates to an oven that has an adjustable effective heating space and particularly to an oven heating mechanism that provides external and manual stepless adjustment of the relative position of a heating tube assembly and foodstuff such that an effective heating space can be set according to foodstuff characteristics.

### BACKGROUND OF THE INVENTION

Baking and roasting food with a conventional oven to get satisfactory results usually is more difficult. This is caused by a number of constraints and drawbacks, notably:

1. The heating space of the conventional oven is fixed. The oven with a smaller heating space can heat quickly but unevenly, and cannot roast foodstuff of a greater size. On the other hand, the oven with a larger heating space heats slower and results in wasting a great amount of electric power.

2. The conventional oven often has a heating means consisting of one or more sets of fixed heating tubes. Adjustment stages and distances are greater, thus cannot fully meet cooking requirements of most people.

3. In principle, the foodstuff of different characteristics requires different types of ovens. Trying to do this has to procure and prepare a number of different ovens. It incurs wastes of money and space.

4. The conventional oven cannot be adjusted instantly according to different conditions of the foodstuff. It makes cooking with the oven less appealing and results in user's frustration.

### SUMMARY OF THE INVENTION

The primary object of the present invention is to overcome the problems and constraints of the conventional oven such as a limited heating area, fixed distance and limited heating modes by providing an oven with an adjustable effective heating space to offer multifunctional baking and roasting environments.

In order to achieve the foregoing object, the invention adopts techniques as follow: an oven body with an adjustable effective heating space including a space control knob to provide external and manual control in a stepless fashion and control the position of an effective heating tube assembly located in the heating space relative to another fixed heating tube so that the adjustable effective heating space is formed. Users can directly adjust the effective heating space from outside whenever desired according to requirements and their judgments. Such a design also can save energy and meet a wide variety of baking and roasting requirements with a single product.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the invention.

FIG. 2 is a front view of the space control knob.

FIG. 3 is a schematic view of a rear space according to the invention, partly cut away.

FIG. 4 is an exploded view of the effective heating tube assembly of the invention.

FIG. 5 is a perspective view of the effective heating tube assembly of the invention.

FIG. 6 is a fragmentary sectional view of the invention showing the relative position of the movable dock and the sliding track.

FIG. 7 is a fragmentary sectional view of the invention showing the relative position of the movable detent plate and the sliding track.

FIG. 8 is a schematic view of the invention in a condition of adjusting the heating assembly.

FIG. 9 is a schematic view of the invention for adjusting the effective heating space.

FIG. 10 is another schematic view of the invention for adjusting the effective heating space.

FIG. 11 is a perspective view of the invention equipped with a hotdog rack.

### DETAILED DESCRIPTION OF THE PREFERRED EMBODIMENTS

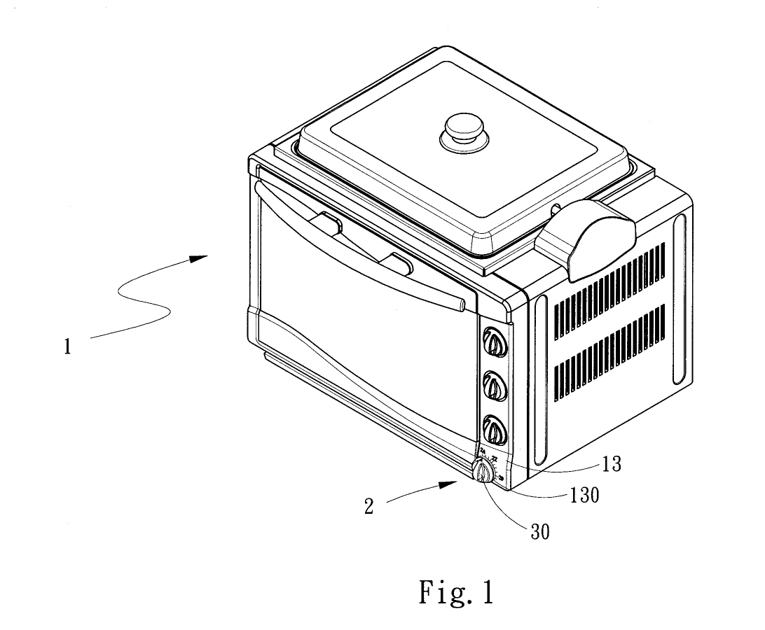

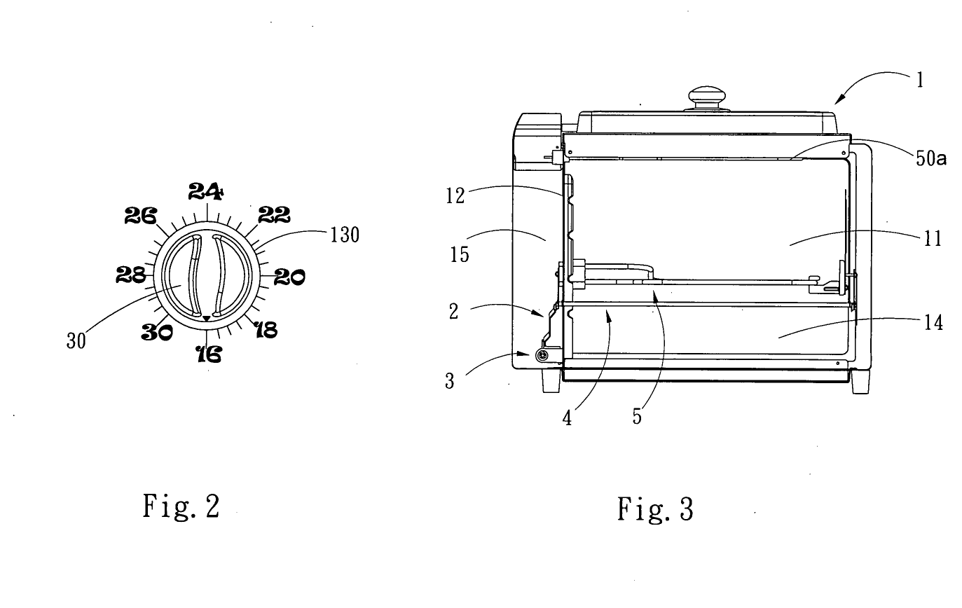

Please refer to FIGS. 1, 2 and 3, an oven having an adjustable effective heating space according to the invention includes an oven body 1 and an effective heating tube assembly 2.

The oven body 1 has a case 13 on the surface, a space control knob 30 hinged on the case 13 and a scale 130 formed on the surface of the case 13 corresponding to the space control knob 30.

Also referring to FIGS. 3, 6 and 7, the case 13 has a side board 12 with a slot 120 formed in the center and a sliding track 121 at a lower side. The side board 12 divides the interior of the oven body 1 into a heating chamber 14 and a facility chamber 15. The heating chamber 14 has a first heating tube 50a at one end.

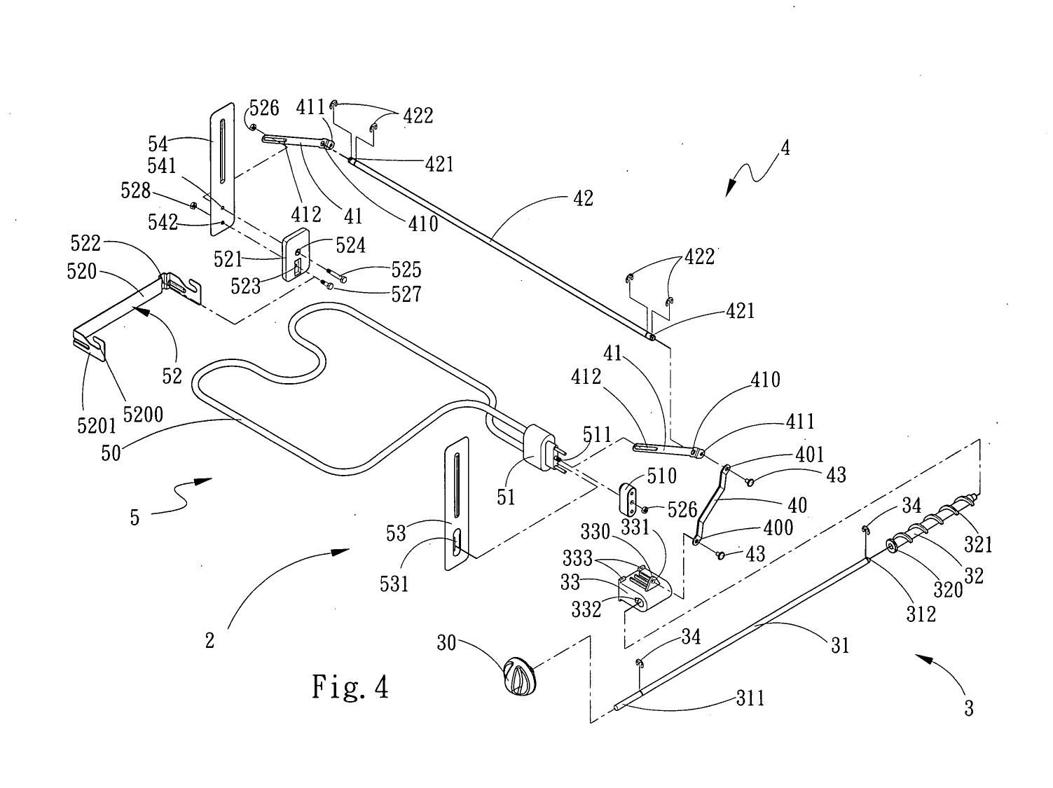

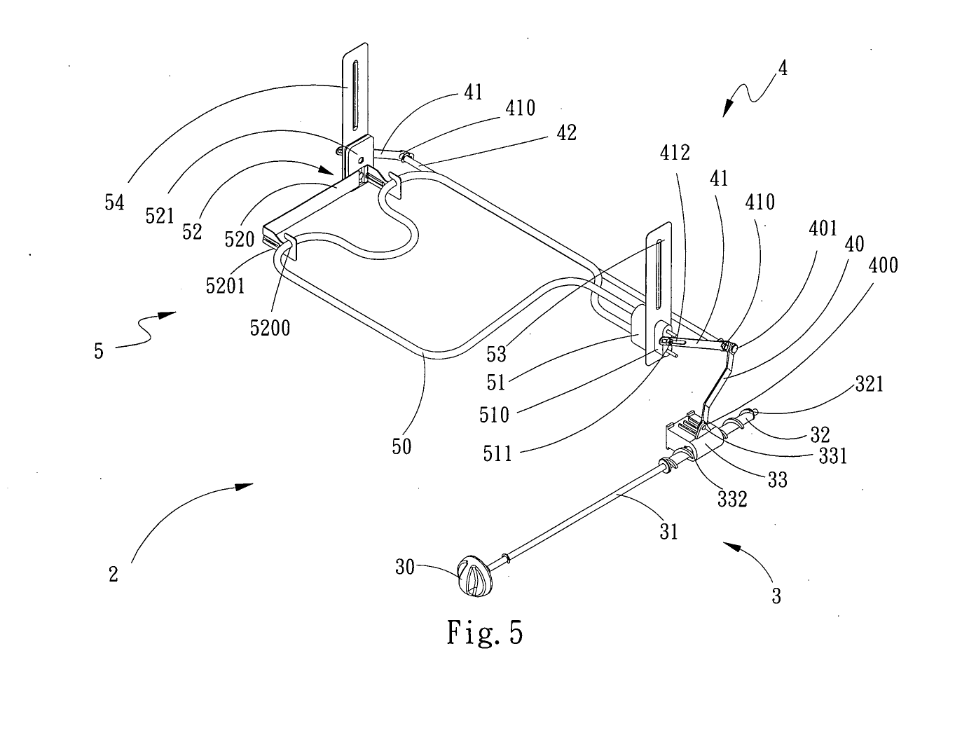

Referring to FIGS. 4 and 5, the effective heating tube assembly 2 includes a transmission assembly 3 and a lever assembly 4 located in the facility chamber 15, and a heating assembly 5 located in the heating chamber 14.

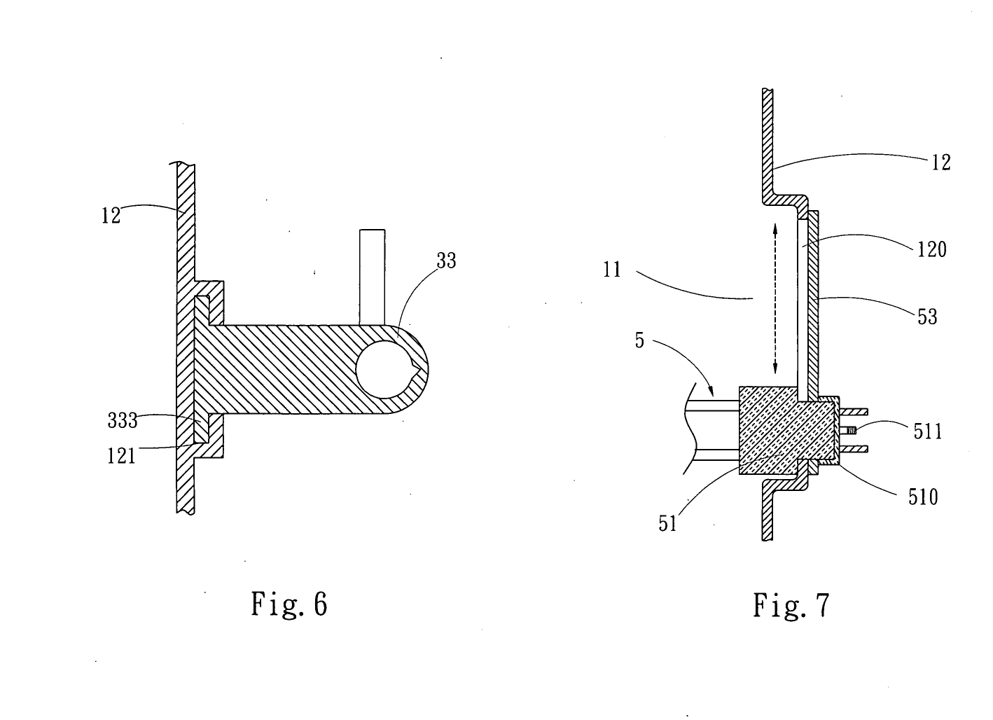

The transmission assembly 3 includes the space control knob 30, an axle 31, a helical sleeve 32 and a movable dock 33. The axle 31 has one end 311 run through the case 13 to couple with the space control knob 30 and another end 312 coupled with the helical sleeve 32, and is clipped respectively by a fastening element 34 such as a latch clip close to two distal ends thereof inside the facility chamber 15 to form a fixed positioning. The helical sleeve 32 has a through hole 320 run through by the another end 312 of the axle 31 and positioned at another side of the facility chamber 15 through another fastening element 34. The helical sleeve 32 has an external thread 321 on the outer side. The movable dock 33 has a lug 330 at an upper side with an aperture 331 formed thereon and an internal thread 332 at a lower side engageable with the external thread 321 of the helical sleeve 32, and movable latch tenons 333 at another side corresponding to each other to be coupled with the sliding track 121 of the side board 12 (referring to FIG. 6) and slidable thereon to prevent shaking during sliding of the movable dock 33.

The lever assembly 4 includes a main lever 40, two secondary levers 41 and a linkage transverse rod 42. The main lever 40 has a first screw hole 400 and a second screw hole 401 at two ends. The first screw hole 400 can be fastened to the aperture 331 of the lug 330 of the movable dock 33 through a fastening element 43 such as a screw. The two secondary levers 41 are coupled with two ends of the linkage transverse rod 42, each has a screw hole 411 corresponding to the second screw hole 401 of the main lever 40 to be hinged together through another fastening element 43 such as a screw. Each of the secondary levers 41 also has a fastening hole 410 at an inner side close to the screw hole 411 and a sliding slot 412 at another end thereof. The linkage transverse rod 42 has a fastening groove 421 close to each of the two ends thereof to be wedged in by a fastening element 422 such as a latch clip at two sides of the fastening hole 410 after each end has run through the fastening hole 410 of the secondary lever 41 to form a secured positioning.

The heating assembly 5 includes a second heating tube 50, a tube seat 51, a bracing rack assembly 52, a first movable detent plate 53 and a second movable detent plate 54. The second heating tube 50 is corresponding to the first heating tube 50a at one end of the heating chamber 14. The second heating tube 50 has one side fastened to one side of the tube seat 51. The tube seat 51 has a bolt 511 at another side coupling with a tube seat cap 510. The second heating tube 50 has other side anchored on the bracing rack assembly 52. The bracing rack assembly 52 includes a first rack 520 with a fastening hole 522 formed thereon and a second rack 521 with a plurality of other fastening holes 523 and a first sliding rod orifice 524 formed thereon. The first rack 520 has two ends forming respectively a bend plate 5201 opposing to each other. Each bend plate 5201 has a latch slot 5200 at one end to latch the other side of the second heating tube 50. The first movable detent plate 53 has a fastening hole 531 at a lower side to be run through by the another side of the tube seat 51, such that the bolt 511 on the tube seat 51 also runs through the sliding slot 412 of the secondary lever 41 and is fastened to the tube seat cap 510. The second movable detent plate 54 has a second sliding rod orifice 541 and a fastening hole 542 at a lower side corresponding to each other. The second sliding rod orifice 541 and the first sliding rod orifice 524 of the second rack 521 and the sliding slot 412 of the secondary lever 41 are run through by another bolt 525, and fastened by a nut 526. The fastening hole 522 of the first rack 520, the fastening hole 523 of the second rack 521 and the fastening hole 542 of the second movable detent plate 54 are run through by another fastening element 527 such as a screw and fastened by another nut 528.

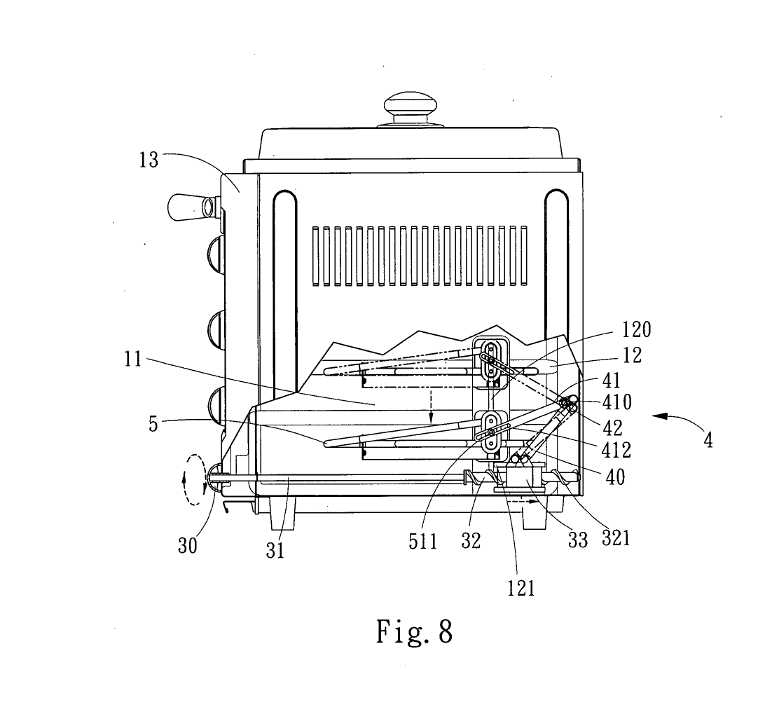

Referring to FIGS. 5 and 8, when the invention is in use, an user turns the space control knob 30 to drive the axle 31 and the helical sleeve 32 to rotate; the movable dock 33 also is moved on the sliding track 121 due to mutual engaging of the external thread 321 and internal thread 330; the main lever 40 also is moved by the movable dock 33 to drive one secondary lever 41 which has one end coupled with the linkage transverse rod 42 through the fastening hole 410 serving as a fulcrum; hence the movement is transmitted to another secondary lever 41 to sway about the linkage transverse rod 42; the bolts 525 and 511 fastened to the two secondary levers 41 and held in the sliding slots 412 are moved along the sliding slot 120 to move the heating assembly 5 up and down.

Referring to FIGS. 7 and 8, when the space control knob 30 is adjusted, the bolts 525 and 511 are driven, and the entire heat assembly 5 is moved up and down along the sliding slot 120 on the side board 12. While an effective heating space 11 is formed in such a movement, the sliding slot 120 forms a crevice of the effective heating space 11. The first movable detent plate 53 can close the crevice to prevent heated air from leaking outwards. Thus the heated air can be trapped in the effective heating space 11 to serve its purpose.

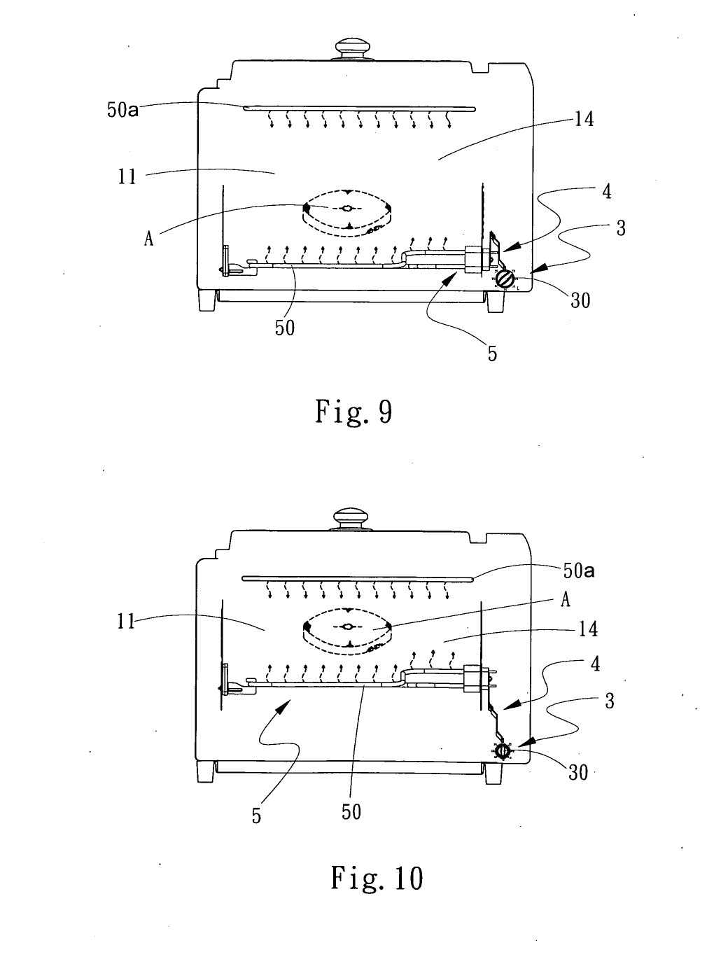

Referring to FIG. 9, when the space control knob 30 is turned, the movable dock 33 is driven to move the lever assembly 4 so that the heating assembly 5 in the heating chamber 14 also is moved up and down to change the size of the effective heating space 11. When the heating assembly 5 is moved closer to a lower side of the heating chamber 14, the effective heating space 11 between the first and second heating tubes 50a and 50 is larger and can evenly roast foodstuff A. When the heating assembly 5 is adjusted and moved to an upper side of the heating chamber 14, referring to FIG. 10, the effective heating space 11 between the two heating tubes 50a and 50 is smaller, thus can roast the foodstuff A at a selected portion.

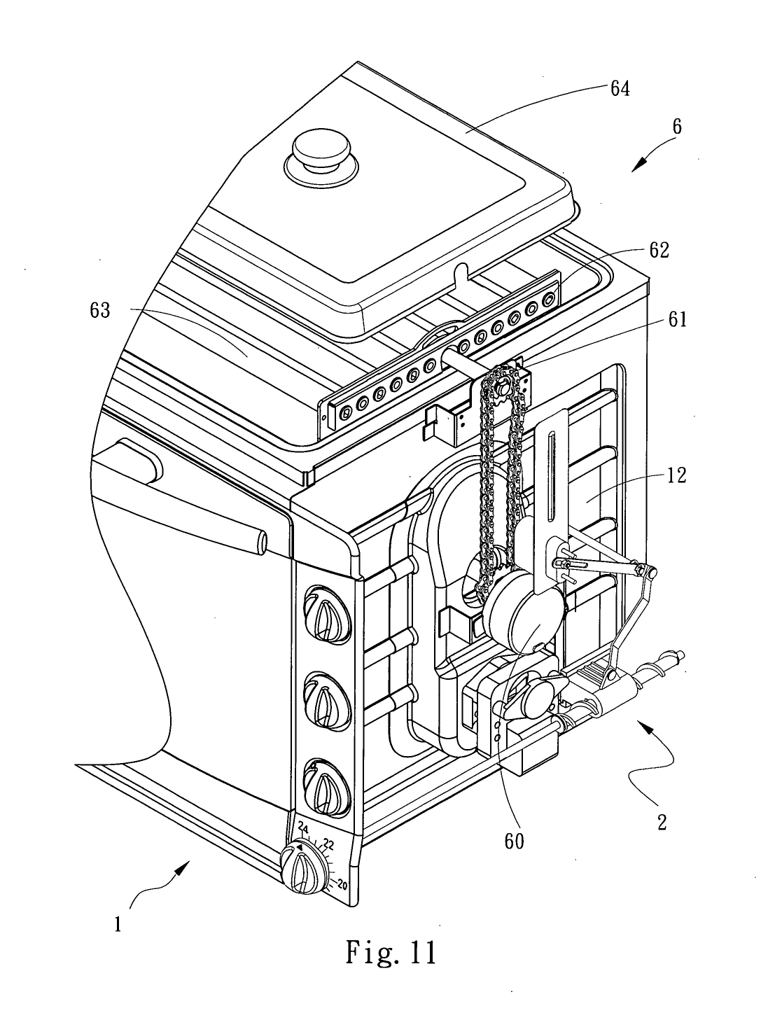

Referring to FIG. 11, the oven body 1 may include an upper lid 64 and a hotdog rack 6 beneath thereof. The hotdog rack 6 has a plurality of hotdog rollers 63. A driving means 62 is provided at one end of the hotdog rack 6 to rotate the hotdog rollers 63. A driving motor 60 also may be provided at the outer side of the side board 12 of the facilitate chamber 15 to drive the driving means 62 through a chain 61 so that the hotdog rollers 63 can be rotated automatically on the hotdog rack 6.

What is claimed is:

1. An oven having an adjustable effective heating space, comprising:
an oven body which has a case and a side board in the case to divide the interior of the case into a heating chamber and a facility chamber, the heating chamber having a first heating tube at one side thereof; and
an effective heating tube assembly which has at least a transmission assembly and a lever assembly located in the facility chamber and a heating assembly located in the heating chamber.

2. The oven of claim 1, wherein the side board has a sliding track.

3. The oven of claim 1, wherein the transmission assembly includes at least one space control knob located on the surface of the case, an axle having one end running through the case to couple with the space control knob and other end coupling with a helical sleeve which has an external thread, and a movable dock screwing on the helical sleeve from an outer side, the movable dock having an internal thread.

4. The oven of claim 3, wherein the case has a scale on the surface corresponding to the space control knob to facilitate adjustment of the size of the effective heating space.

5. The oven of claim 3, wherein the movable dock has movable latch tenons that correspond to each other.

6. The oven of claim 1, wherein the lever assembly has at least one main lever, two secondary levers and a linkage transverse rod.

7. The oven of claim 6, wherein the main lever has two ends each having a first screw hole, the two secondary levers being coupled with two ends of the linkage transverse rod and having one end formed a second screw hole corresponding to the first screw hole to hinge on the main lever through a fastening element and a fastening hole at an inner side close to the second screw hole and a sliding slot at other end thereof, the linkage transverse rod having a fastening groove close to each of the two ends thereof to run through the fastening hole of the secondary levers and be latched.

8. The oven of claim 1, wherein the heating assembly includes at least a second heating tube, a tube seat fastened to one side of the second heating tube, a bracing rack assembly to anchor other side of the second heating tube and a first movable detent plate and a second movable detent plate.

9. The oven of claim 8, wherein the tube seat has a bolt at one side to engage with a tube seat cap, the bracing rack assembly having a first rack with a fastening hole formed thereon and a second rack which has a plurality of other fastening holes and a first sliding rod orifice formed thereon, the first rack having two ends bent to form two bend plates opposing to each other, each of the bend plates having a latch slot, the first movable detent plate having a fastening hole at a lower side, the second movable detent plate having a second sliding rod orifice and another fastening hole corresponding to each other.

10. The oven of claim 1, wherein the oven body has a hotdog rack at an upper side containing a plurality of rollers, the hotdog rack having one end pivotally coupled with a driving motor to transmit motion through a chain.
